(19) United States
(12) Patent Application Publication
(10) Pub. No.: US 2022/0405820 A1
(43) Pub. Date: Dec. 22, 2022

(54) AUTOMOTIVE SERVICE HUB APPLICATION

(71) Applicants: Daniel ARENT, Newmarket (CA); Gregory Thomas BACHMANN, Wasaga Beach (CA)

(72) Inventors: Daniel ARENT, Newmarket (CA); Gregory Thomas BACHMANN, Wasaga Beach (CA)

(21) Appl. No.: 17/351,995

(22) Filed: Jun. 18, 2021

(51) Int. Cl. G06Q 30/06; G06F 16/22

(52) U.S. Cl. CPC G06Q 30/0629; G06F 16/22

(57) ABSTRACT

An automotive service price comparison application is provided. An application executed on a processor of a computing device, for comparing a plurality of automotive service prices across a plurality of service locations, comprising a display module of the computing device capable of displaying one or more of the plurality of service locations related to a GPS defined area, one or more price lists and reviews and a service history of one or more users. The price lists containing one or more automotive services provided by each of the plurality service locations wherein one of the one or more reviews for the one or more service locations is completed by the one of the one or more users and a database, coupled to the application, for storing the one or more price lists of automotive services, the one or more reviews and the service history of the one or more users.

### FIELD OF THE INVENTION

The present disclosure relates to an automotive service price comparison application more specifically, but not by way of limitation, more particularly to an application for vehicle owners to locate dealers, shops and repair facilities to be able to compare pricing and labor times for automotive repairs and maintenance.

### BACKGROUND

Most consumers are not loyal to one brand or one shop but desire reliable services and products at fair prices. Consumers are constantly searching for the best deal or even just a fair price. Current automotive service apps on the market are based on a bidding system, which can complicate pricing of a service for a user. Additionally, most dealerships use a flat rate system and users may receive several quotes across multiple service locations based on expected labor hours. Some service locations require a minimum amount of the labor hours to accept a job, such as a two hour minimum, which can affect these estimates.

U.S. Pat. No. 8,886,389 B2 (Edwards et al.) discloses a method of providing directions to a vehicle service facility. Shortcomings include an inability to compare pricing and labor times for certain repairs and maintenance based on the user's vehicle identification numbers and/or manually input of additional vehicle information in order to obtain a fair price for the user for the work done on their vehicle, a lack automotive part replacement details as to whether or not the replacement part is from an original equipment manufacturer or is an aftermarket product for the user, a lack of reviews for the work completed by the locate dealers, automotive shops and repair facilities, an inability to prompt a user of a potential vehicle maintenance, repair or recall based on an inputted service history and provide dealership and/or local roadside assistance information.

U.S. Pat. No. 9,721,301 B2 (Cook) discloses a vehicle repair cost estimate acquisition system and method. Shortcomings include a lack automotive part replacement details as to whether or not the replacement part is from an original equipment manufacturer or is an aftermarket product for the user, a lack of reviews for the work completed by the locate dealers, automotive shops and repair facilities, an inability to prompt a user of a potential vehicle maintenance, repair or recall based on an inputted service history and provide dealership and/or local roadside assistance information.

U.S. Pat. No. 10,217,150 B2 (Sells et al.) discloses an auto repair quote platform for obtaining vehicle servicing, repairs and parts pricing, scheduling and payment. Shortcomings include a lack automotive part replacement details as to whether or not the replacement part is from an original equipment manufacturer or is an aftermarket product for the user, a lack of reviews for the work completed by the locate dealers, automotive shops and repair facilities, an inability to prompt a user of a potential vehicle maintenance, repair or recall based on an inputted service history and provide dealership and/or local roadside assistance information.

U.S. Pat. No. 10,692,050 B2 (Taliwal et al.) discloses an automatic assessment of damage and repair costs in vehicles. Shortcomings include a lack automotive part replacement details as to whether or not the replacement part is from an original equipment manufacturer or is an aftermarket product for the user, a lack of reviews for the work completed by the locate dealers, automotive shops and repair facilities, an inability to prompt a user of a potential vehicle maintenance, repair or recall based on an inputted service history and provide dealership and/or local roadside assistance information.

U.S. Pub. No. 2012/0136743 A1 (McQuade et al.) discloses a system and method for obtaining competitive pricing for vehicle systems. Shortcomings include a lack of automotive part replacement details as to whether or not the replacement part is from an original equipment manufacturer or is an aftermarket product for the user, a lack of dealership and/or local roadside assistance information, an inability to provide the transfer of a user's service history to another user after the sale of the vehicle and an inability to prompt a user of a potential vehicle maintenance, repair or recall based on an inputted service history, provides dealership and/or local roadside assistance information.

W.O. Pub. No. 2014/078983 A1 (Ma) discloses a system for providing address information of a vehicle maintenance shop capable of providing a maintenance service for a vehicle's needs. Shortcomings include an inability to compare pricing and labor times for certain repairs and maintenance based on the user's vehicle identification numbers and/or manually input of additional vehicle information in order to obtain a fair price for the user for the work done on their vehicle, a lack automotive part replacement details as to whether or not the replacement part is from an original equipment manufacturer or is an aftermarket product for the user, a lack of reviews for the work completed by the locate dealers, automotive shops and repair facilities, an inability to prompt a user of a potential vehicle maintenance, repair or recall based on an inputted service history and provide dealership and/or local roadside assistance information.

U.S. Pub. No. 2017/0132575 A1 (Buren) discloses a system and method for obtaining vehicle servicing, repairs and parts pricing. Shortcomings include the production of a one-time cost which must be generated for each user each time they perform a vehicle part/service/repair price search and is not publicly available to other service locations, a lack automotive part replacement details as to whether or not the replacement part is from an original equipment manufacturer or is an aftermarket product for the user, and a lack of reviews for the work completed by the locate dealers, automotive shops and repair facilities.

U.S. Pub. No. 2017/0278020 A1 (Noe et al.) discloses a mobile application for automotive services that supports automotive sales and service providers as well as drivers. Shortcomings include a lack automotive part replacement details as to whether or not the replacement part is from an original equipment manufacturer or is an aftermarket product for the user, a lack of reviews for the work completed by the locate dealers, automotive shops and repair facilities, an inability to prompt a user of a potential vehicle maintenance, repair or recall based on an inputted service history and provide dealership and/or local roadside assistance information.

U.S. Pub. No. 2018/0018731 A1 (Rodriguez) discloses a vehicle servicing system for obtaining vehicle servicing, repairs and parts pricing, scheduling, payment and repair time for the user. Shortcomings include a lack of automotive part replacement details as to whether or not the replacement part is from an original equipment manufacturer or is an aftermarket product for the user, an inability to prompt a user of a potential vehicle maintenance, repair or recall based on an inputted service history and an inability to provide dealership and/or local roadside assistance information.

U.S. Pub. No. 2019/0234756 A1 (Lin et al.) discloses a method and system associated with a vehicle using navigation function of a portable device to assist a driver of the vehicle in finding a facility providing a service required by the vehicle. Shortcomings include a lack automotive part replacement details as to whether or not the replacement part is from an original equipment manufacturer or is an aftermarket product for the user, a lack of reviews for the work completed by the locate dealers, automotive shops and repair facilities, an inability to prompt a user of a potential vehicle maintenance, repair or recall based on an inputted service history and provide dealership and/or local roadside assistance information.

All documents cited herein are incorporated by reference.

There is a need for an automotive service price comparison application that conveniently connects vehicle owners to locate dealers, automotive shops and repair facilities, within a defined area, to be able to compare pricing and labor times for certain repairs and maintenance based on the user's vehicle identification numbers and/or manually input of additional vehicle information in order to obtain a fair price for the user for the work done on their vehicle, that has the ability to prompt a user of a potential vehicle maintenance, repair or recall based on an inputted service history, provides dealership and/or local roadside assistance information, provides the transfer of a user's service history to another user after the sale of the vehicle, provides the user automotive part replacement details as to whether or not the replacement part is from an original equipment manufacturer or is an aftermarket product and provides reviews for the work completed by the locate dealers, automotive shops and repair facilities.

### BRIEF SUMMARY

It is the object of the present invention to provide an automotive service price comparison application. An automotive service price comparison application executed on a processor of a computing device, for comparing a plurality of automotive service prices across a plurality of service locations, comprising a display module of the computing device capable of displaying one or more of the plurality of service locations related to a GPS defined area, one or more price lists, one or more reviews and a service history of one or more users. The one or more price lists containing one or more automotive services provided by each of the plurality service locations wherein one of the one or more reviews for the one or more service locations is completed by the one of the one or more users and a database, coupled to the application, for storing the one or more price lists of automotive services, the one or more reviews and the service history of the one or more users.

In accordance with an aspect of the invention, there is provided a method for a user to compare a plurality of automotive service prices across a plurality of service locations on an automotive service price comparison application executed on a processor of a computing device comprising entering one or more user vehicle inputs into a service history of the automotive service price comparison application, setting a GPS defined area and displaying one or more price lists from one or more service locations within the set GPS defined area.

In accordance with an aspect of the invention, there is provided a method for a service location to input one or more automotive service prices on an automotive service price comparison application executed on a processor of a computing device comprising entering one or more of automotive services into a price list of the automotive service price comparison application, setting a service rate for each of the one or more automotive services and setting a location.

In accordance with an embodiment of the invention, the one or more automotive services are of the group comprising an automotive repair, automotive maintenance, automotive part replacement, automotive component evaluation, automotive system evaluation, or general labor over a fixed period of time.

In accordance with an embodiment of the invention, the automotive part replacement details whether or not the replacement part is from an original equipment manufacturer or is an aftermarket product.

In accordance with an embodiment of the invention, the automotive service price comparison application provides roadside assistance information for the one or more service locations.

In accordance with an embodiment of the invention, the one or more service locations are of the group comprising a dealership, a private garage or a chain store garage.

In accordance with an embodiment of the invention, the automotive service price comparison application compares automotive service times for each of the automotive services provided by each of the service locations.

In accordance with an embodiment of the invention, the automotive service price comparison application facilitates said one or more users scheduling said one or more automotive services from said one or more service locations.

In accordance with an embodiment of the invention, the automotive service price comparison application facilitates the one or more users purchasing the one or more automotive services from the one or more service locations.

In accordance with an embodiment of the invention, the automotive service price comparison application notifies the one or more users of an expected automotive service requirement based on the service history.

In accordance with an embodiment of the invention, the service history is of the group comprising one or more automotive repairs performed, one or more automotive maintenance performed, one or more automotive part replacement performed, one or more automotive component evaluation performed, one or more automotive system evaluation performed and a vehicle identification number.

In accordance with an embodiment of the invention, the service history may be transferred to the one or more users.

In accordance with an embodiment of the invention, the GPS defined area is based on a set radius.

In accordance with an embodiment of the invention, the set radius is adjustable.

In accordance with an embodiment of the invention, the vehicle inputs are of the group comprising a vehicle identification number, a vehicle make, a vehicle model, a vehicle year and vehicle type.

In accordance with an embodiment of the invention, the service locations set an estimated automotive service time for the one or more automotive services.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

The present invention describes an automotive service price comparison application that overcomes disadvantages inherent in the known methods and systems of automotive service price comparison. The present invention provides an automotive service price comparison application, particularly an application, utilizing a database of automotive service price lists to facilitate a local directory for automotive services. As such, the general purpose of the present invention, which will be described subsequently in greater detail, is to provide a new and improved an automotive service price comparison application which has all the advantages of the automotive service pricing tools and none of the disadvantages.

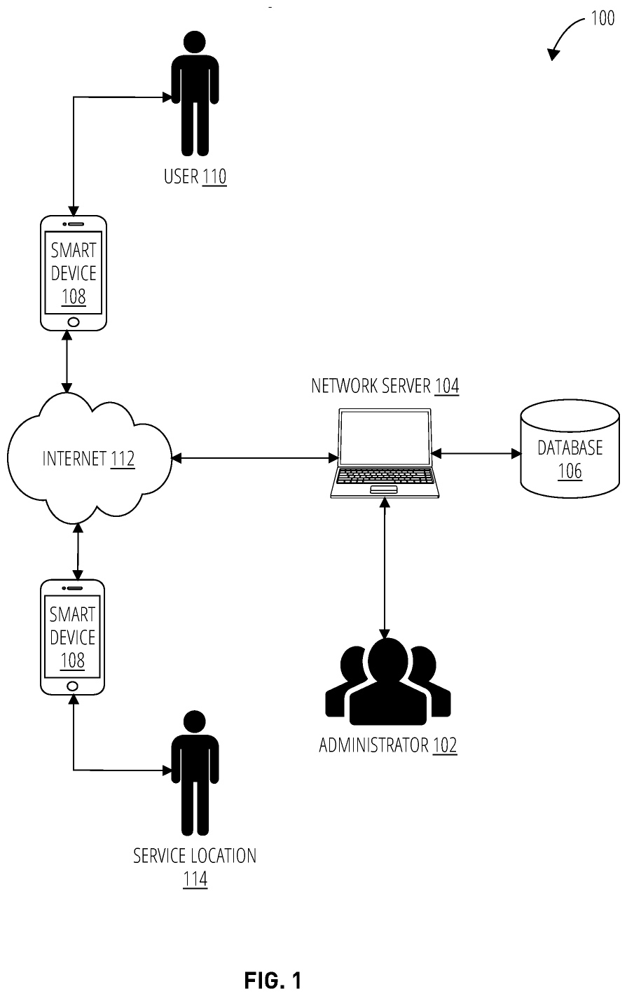

FIG. 1 provides a high-level diagram 100 of an automotive service price comparison application as in one embodiment. An administrator 102 establishes a list of automotive services and associated costs on a network server 104 based on a vehicle manufacturer repair and parts catalogue per vehicle type, make, model and year, which is stored in a database 106. A user 110 may access the automotive service price comparison application on a smart device 108 connected to the network server 104 via the internet 112. Users 110 may request one or more lists of automotive services from the network server 104 for retrieval from the database 106 or input information to network server 104 and to the database 106 for future reference.

Similarly, a service location 114 may access the automotive service price comparison application on a smart device 108 connected to the network server 104 via the internet 112. A service location 114 input one or more lists of automotive services with associated prices to the network server 104 and to the database 106 for future reference.

The automotive service price comparison application is executed on a processor of a computing device and is employed for comparing a plurality of automotive service prices across a plurality of service locations 114. The automotive service price comparison application comprises a display module of the computing device capable of displaying one or more of the plurality of service locations 114 related to a GPS defined area, with one or more price lists containing one or more automotive services provided by the one or more service locations 114. One or more reviews for the one or more service locations 114 may be completed by one or more users 110 based on service quality and experience where the database 106 is employed for storing the one or more price lists of automotive services, the one or more reviews and a service history of the one or more users 110. The one or more price lists contain one or more automotive services provided by each of the plurality service locations 114 wherein one of the one or more reviews for the one or more service locations 114 is completed by the one of the one or more users 110 and a database 106, coupled to the application, stores the one or more price lists of automotive services, the one or more reviews and the service history of the one or more users 110.

Storing automotive service invoices in the automotive service price comparison application allows for further comparison between service locations 114 and analytics of other information. The storage of user 110 information provides individual users 110 access to their full vehicle history without having to file and store “paper copies”. Furthermore, users 110 may send or share vehicle history files with friends, family or anyone they choose to share it with. For personal security, users 110 have the option to cover or blank out all personal information on invoices being stored in the automotive service price comparison application. For example, the user 110 can blank out name, address, phone number, email, License plate etc. but can't blank out their vehicle identification number or vehicle info other than license plate. In some embodiments, a hard drive may be coupled to the automotive service price comparison application and the user's 110 vehicle to store service history. In some embodiments, the storing of automotive invoices or automotive services in the automotive service price comparison application may be completed by taking a picture or uploading an emailed invoice with a status as to whether or not the automotive services were completed or uncompleted work. This allows a user 110 to indicate that they were recommended a certain automotive service, such as installing new brakes, but the user 110 declined to proceed with the automotive service. If the user 110 later decides that they want to do proceed with installing new brakes, the user 110 can access the previous quote and compare it with other nearby service locations 114.

In some embodiments, the automotive part replacement details whether or not the replacement part is from an original equipment manufacturer or is an aftermarket product. This detail allows users 110 to better understand price disparity in automotive service prices as service locations 114 may employ aftermarket products to lower automotive service prices at the expense of quality automotive part performance and longevity.

In some embodiments, the automotive service price comparison application provides roadside assistance information for said one or more service locations. A roadside assistance icon may be implemented on the automotive service price comparison application if a user 110 inputs a warranty timeline for their vehicle manufacturer or dealership linking to roadside information. In other embodiments, towing company information and/or insurance company information may be provided by the automotive service price comparison application such that the towing company and insurance company can arrange tow for the user 110 if the user 110 is no longer under warranty. In some embodiments, the one or more service locations are of the group comprising a dealership, a private garage or a chain store garage such as but not limited to Canadian tire, Midas, Activgreen and Ross, etc. In some embodiments, the automotive service price comparison application compares automotive service times for each of the automotive services provided by each of the service locations 114. This allows users 110 a metric beyond just automotive service price to weigh while deciding between service locations 114.

In one example, if a user 110 has a 2015 VW Golf and is looking for quotes on front brakes, the VW dealer may charge 1.5 hours for this, the shop labor rate may be $135.00/hr, and the parts price may be $220.00. The automotive service price comparison application will provide a price list for this service location 114 as 1.5 hrs, ×$135.00/hr labor+$320.00 parts=$522.50+tax. Alternatively, a smaller shop may show as 2.5 hr×$90/hr+cost of parts. The automotive service price comparison application may also display tiered display, such as the top 3 benefits of each tier. For example, a dealership may display that they use genuine parts, that they have factory trained technicians, or that they offer valet service, whereas an independent shop may advertise that they have lower labor costs and a shuttle service. In example above, if industry set times are 1.5 hr for the vehicle for a selected job, labor at VW appears to be less although labor rate is higher, that is because the smaller shop has a lower labor door rate but charges more hours to do the same repair. That is why it is important to show the labor time comparison, dealerships are not always more expensive to service at as many consumers may believe. The automotive service price comparison application may also display the industry suggested repair time set out by Mitchel or AllData and/or by using the manufacturer's warranty times and customer pay times to obtain a standard retail rate for labor time. The vehicle information number decoder within the automotive service price comparison application determines which parts belong to the selected vehicle for more accurate pricing quotes.

In other embodiments, the automotive service price comparison application facilitates a user 110 to schedule one or more automotive services from one or more service locations 114. In some embodiments, the automotive service price comparison application facilitates a user 110 to purchase one or more automotive services from one or more service locations 114. In some embodiments, the automotive service price comparison application notifies a user 110 of an expected automotive service requirement, manufacturer maintenance guidelines or any recall information from Transport Canada based on their service history. In some embodiments, the service history is of the group comprising one or more automotive repairs performed, one or more automotive maintenance performed, one or more automotive part replacement performed, one or more automotive component evaluation performed, one or more automotive system evaluation performed and a vehicle identification number.

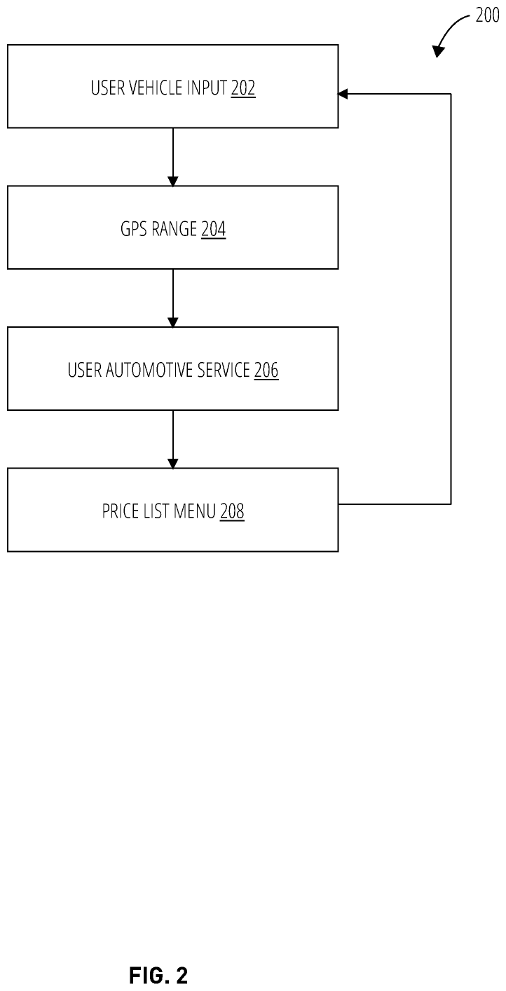

FIG. 2 depicts a motorist workflow 200 of the automotive service price comparison application as in one embodiment. In this example, a method for a user 110 to compare a plurality of automotive service prices across a plurality of service locations 114 on an automotive service price comparison application executed on a process of a computing device comprises entering one or more user vehicle input 202 into the automotive service price comparison application. The user 110 sets a GPS range 204 from a present location or a defined location to populate a plurality of service locations 114 within that range. In some embodiments, the GPS range 204 is a defined area is based on a set radius and may be adjusted by the user 110. The resulting price list menus 208 are displayed from the service locations 114 within the set GPS range 204. The user 110 selects one or more automotive services provided by the one or more service locations 114 within the set GPS range 204. The user 110 can repeat the method presented to change one or more of the user vehicle inputs 202, GPS range 204, user automotive services 206 and price list menu 208 in order to compare against other service locations 114.

In some embodiments, one or more automotive services are from the group comprising an automotive repair, automotive maintenance, automotive part replacement, automotive component evaluation, automotive system evaluation, or general labor over a fixed period of time. In some embodiments, the user vehicle inputs 202 are of the group comprising a vehicle identification number, a vehicle make, a vehicle model, a vehicle year and vehicle type.

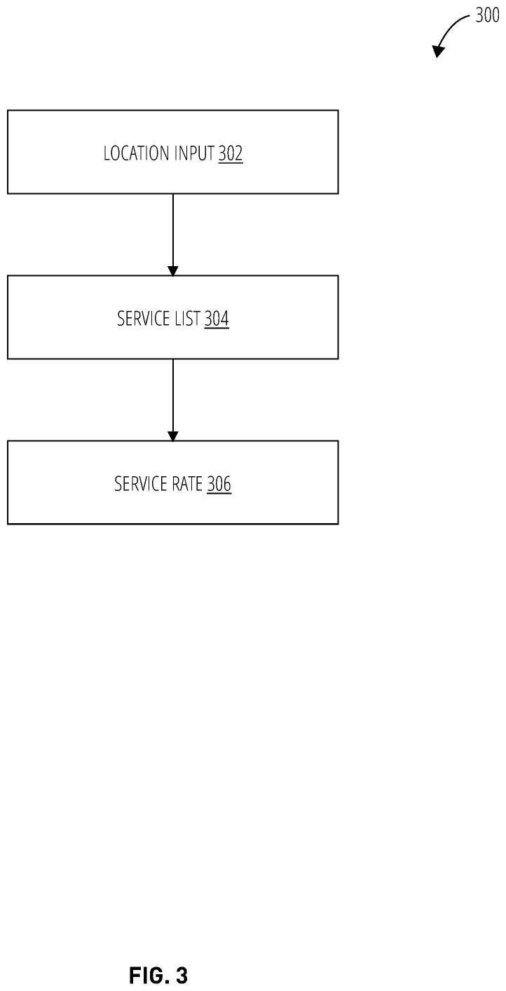

FIG. 3 depicts a service location workflow 300 of the automotive service price comparison application as in one embodiment. In this example, a method for a service location 114 to input one or more automotive service prices on an automotive service price comparison application executed on a processor of a computing device comprising entering one or more of automotive services into a price list of the automotive service price comparison application, setting a service rate 306 for each of the one or more automotive services and setting a location.

The service location 114 inputs their location 302 to make themselves visible to users 110 within a desired range. The service location 114 inputs a service list 304 comprising any inspections, repairs, maintenance they may perform and inputs an associated price and/or expected period of time it will take to complete the automotive service. In some embodiments, the service locations 114 may be prompted to input automotive services prices from the vehicle manufacturer repair and parts catalogue to price out repair times and part prices and may choose to adjust their price accordingly. In some embodiments, further comprising said service locations 114 setting an estimated automotive service time for said one or more automotive services.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

What is claimed is:

1. An automotive service price comparison application executed on a processor of a computing device, for comparing a plurality of automotive service prices across a plurality of service locations, comprising:
a display module of said computing device capable of displaying one or more of said plurality of service locations related to a GPS defined area, one or more price lists, one or more reviews and a service history of one or more users;
said one or more price lists containing one or more automotive services provided by each of said plurality service locations;
wherein one of said one or more reviews for said one or more service locations is completed by said one of said one or more users; and
a database, coupled to said application, for storing said one or more price lists of automotive services, said one or more reviews and said service history of said one or more users.

2. The automotive service price comparison application of claim 1, wherein said one or more automotive services are of the group comprising an automotive repair, automotive maintenance, automotive part replacement, automotive component evaluation, automotive system evaluation, or general labor over a fixed period of time.

3. The automotive service price comparison application of claim 2, wherein said automotive part replacement details whether or not the replacement part is from an original equipment manufacturer or is an aftermarket product.

4. The automotive service price comparison application of claim 1, wherein said automotive service price comparison application provides roadside assistance information for said one or more service locations.

5. The automotive service price comparison application of claim 1, wherein said one or more service locations are of the group comprising a dealership, a private garage or a chain store garage.

6. The automotive service price comparison application of claim 1, wherein said automotive service price comparison application compares automotive service times for each of said automotive services provided by each of said service locations.

7. The automotive service price comparison application of claim 1, wherein said automotive service price comparison application facilitates said one or more users scheduling said one or more automotive services from said one or more service locations.

8. The automotive service price comparison application of claim 7, wherein said automotive service price comparison application facilitates said one or more users purchasing said one or more automotive services from said one or more service locations.

9. The automotive service price comparison application of claim 1, wherein said automotive service price comparison application notifies said one or more users of an expected automotive service requirement based on said service history.

10. The automotive service price comparison application of claim 1, wherein said service history is of the group comprising one or more automotive repairs performed, one or more automotive maintenance performed, one or more automotive part replacement performed, one or more automotive component evaluation performed, one or more automotive system evaluation performed and a vehicle identification number.

11. The automotive service price comparison application of claim 1, wherein said service history may be transferred to said one or more users.

12. The automotive service price comparison application of claim 1, wherein said GPS defined area is based on a set radius.

13. The automotive service price comparison application of claim 12, wherein said set radius is adjustable.

14. A method for a user to compare a plurality of automotive service prices across a plurality of service locations on an automotive service price comparison application executed on a processor of a computing device comprising:
entering one or more user vehicle inputs into a service history of said automotive service price comparison application;
setting a GPS defined area; and
displaying one or more price lists from one or more service locations within said set GPS defined area.

15. The method of claim 14, wherein said vehicle inputs are of the group comprising a vehicle identification number, a vehicle make, a vehicle model, a vehicle year and vehicle type.

16. A method for a service location to input one or more automotive service prices on an automotive service price comparison application executed on a processor of a computing device comprising:
entering one or more of automotive services into a price list of said automotive service price comparison application;
setting a service rate for each of said one or more automotive services; and
setting a location.

17. The method of claim 16 further comprising said service locations setting an estimated automotive service time for said one or more automotive services.
